(19) United States
(12) Patent Application Publication
(10) Pub. No.: US 2013/0216465 A1
(43) Pub. Date: Aug. 22, 2013

(54) POLYSILANES OF MEDIUM CHAIN LENGTH AND A METHOD FOR THE PRODUCTION OF SAME

(71) Applicants: Norbert Auner, Glashuetten (DE); Christian Bauch, Muldenstein (DE); Rumen Deltschew, Leipzig (DE); Sven Holl, Gueckingen (DE); Javad Mohsseni, Bitterfeld (DE)

(72) Inventors: Norbert Auner, Glashuetten (DE); Christian Bauch, Muldenstein (DE); Rumen Deltschew, Leipzig (DE); Sven Holl, Gueckingen (DE); Javad Mohsseni, Bitterfeld (DE)

(73) Assignee: Sprawnt Private S.a.r.l., Luxembourg (LU)

(21) Appl. No.: 13/807,052

(22) PCT Filed: Jul. 4, 2011
(86) PCT No.: PCT/EP2011/061258

§ 371 Date: Apr. 8, 2013

(30) Foreign Application Priority Data
Jul. 2, 2010 (DE) 10 2010 025 948.9

(51) Int. Cl. C01B 33/107

(52) U.S. Cl. CPC C01B 33/107
USPC 423/342

(57) ABSTRACT

Polysilanes of medium chain length as pure compounds or a mixture of compounds, each having at least one direct Si—Si bond, the substituents of the polysilanes consisting exclusively of halogen and/or hydrogen, the medium chain length n thereof being greater than 3 and smaller than 50, and the atomic ratio of substituent:silicon in the composition thereof being at least 1:1.

### RELATED APPLICATIONS

This is a §371 of International Application No. PCT/EP2011/061258, with an international filing date of Jul. 4, 2012 (WO 2012/001180 A1, published Jan. 5, 2012), which is based on German Patent Application No. 10 2010 025 948.9, filed Jul. 2, 2010, the subject matter of which is incorporated herein by reference.

### TECHNICAL FIELD

This disclosure relates to polysilanes of medium chain length as a pure compound or mixture of compounds having at least one direct Si—Si bond in each case, the substituents of which consist exclusively of halogen and/or hydrogen and the composition of which has an atomic substituent:silicon ratio of at least 1:1, and to methods for preparation thereof.

### BACKGROUND

Polysilanes have been prepared by numerous methods, for example, by heating vaporous chlorosilanes with or without a reducing agent to relatively high temperatures (above 700° C.). The chlorinated polysilanes (PCS) thus obtained, however, merely have a high proportion of short-chain, branched and/or cyclic molecules and are additionally contaminated with solvent/catalyst or substances from the reactor walls. In addition, a disadvantage of the processes for preparing polysilanes is that they do not demonstrate particularly efficient preparation of polysilanes of medium chain length in usable yields. Moreover, past methods lack polysilanes which will play an important role for future industrial processes due to their exceptional properties.

It could therefore be helpful to provide polysilanes of medium chain length as a pure compound or mixture of compounds having at least one direct Si—Si bond in each case, the substituents of which consist exclusively of halogen and/or hydrogen and the composition of which has an atomic substituent:silicon ratio of at least 1:1, and a method for preparation thereof to achieve a particularly efficient preparation of such polysilanes.

### SUMMARY

We provide a polysilane of medium chain length as a pure compound or mixture of compounds having at least one direct Si—Si bond in each case, substituents of which consist of halogen and/or hydrogen and a composition of which has an atomic substituent:silicon ratio of at least 1:1, wherein a) the medium chain length is greater than 3 and less than 50, b) the polysilane is soluble in inert solvents, c) the polysilane is suitable as a starting material for silicon deposition, d) the polysilane has oxygen- and chlorine-binding properties, and e) the polysilane decomposes to longer- and shorter-chain products on thermal treatment.

### BRIEF DESCRIPTION OF THE DRAWING

FIG. 1 shows a ²⁹Si NMR spectrum of an isomer mixture of chlorinated pentasilanes.

### DETAILED DESCRIPTION

The chemical properties of our polysilanes of medium chain length are notable for the presence of direct Si—Si bonds as a result of which these substances have a strong affinity for oxygen and chlorine and are suitable for binding of these elements. For example, chlorinated oligosilanes are used for deoxygenation reactions. Our polysilanes are additionally completely soluble in suitable inert solvents due to their mean chain length of greater than 3 and less than 50, preferably greater than 3 and less than 9, more preferably greater than 3 and less than 7. Some of them have a significant vapor pressure above 1 Pa (less than 500 hPa) at 200° C., i.e., well below their decomposition temperatures, which are typically above 250° C., which makes them suitable for use for deposition of silicon from the gas or liquid phase. The vapor pressure is preferably more than 1 hPa and less than 1000 hPa at 200° C. Particular emphasis should be given to the property of our polysilanes that pure silicon can be obtained therefrom by suitable processes, for example, tempering at high temperatures, due to the molecular composition thereof.

Another feature common to our polysilanes is that they disproportionate in the course of thermal treatment, i.e., decompose to longer- and shorter-chain products.

Preferably, the brominated or hydrogenated polysilanes are colorless to pale yellow. The chlorinated polysilanes are colorless to greenish-yellow, intense orange or red-brown.

The polysilanes of medium chain length are liquid or viscous to solid, depending on the molecular structure thereof. Polysilanes which are solids in pure form may, however, also be present partly or fully dissolved in liquid polysilanes.

The polysilanes appropriately have a metal content of less than 1%.

For deposition of crystalline silicon, preference is given to using polysilanes containing less than 2 atom % of hydrogen.

For specific liquid coating processes, preference is given to using polysilanes which contain predominantly linear long chains and virtually no short branched chain and ring compounds. In this context, the content of branching sites in the short-chain component based on the overall product is preferably less than 2%.

For deposition reactions at low temperatures, particular preference is given to using polysilanes whose substituents consist exclusively of hydrogen.

The substituents of the polysilanes preferably consist exclusively of halogen or of halogen and hydrogen.

The polysilanes of medium chain length may also contain halogen substituents of a plurality of different halogens.

For specific liquid coating processes, preference is given to using polysilanes whose average size of the base structure is n=8-20. Particular preference is given to using polysilanes whose average size of the base structure is, after distillative removal of the short-chain component, n=15-30.

Spectroscopic characterization:
Polysilanes have
   a) only bands in the range of less than 2400 wavenumbers in the IR molecular vibration spectra thereof,
   b) only bands in the range of less than 2300 wavenumbers in Raman molecular vibration spectra.
Polysilanes whose substituents consist of fluorine have
   a) significant product signals in ²⁹Si NMR spectra within the chemical shift range from 8 ppm to −40 ppm and/or from −45 ppm to −115 ppm,
   b) typical Raman intensities not outside the ranges of 10 cm⁻¹ to 165 cm⁻¹, 170 cm⁻¹ to 240 cm⁻¹, 245 cm⁻¹ to 360 cm⁻¹, 380 cm⁻¹ to 460 cm⁻¹, and 480 cm⁻¹ to 650 cm⁻¹ and at 900 cm⁻¹ to 980 cm⁻¹.
Polysilanes whose substituents consist of chlorine have
   a) significant product signals in ²⁹Si NMR spectra within the chemical shift range from 15 ppm to −10 ppm, from −25 ppm to −40 ppm and/or −65 ppm to −96 ppm,
   b) typical Raman intensities not outside the ranges of 10 cm⁻¹ to 165 cm⁻¹, 170 cm⁻¹ to 240 cm⁻¹, 245 cm⁻¹ to 360 cm⁻¹, 380 cm⁻¹ to 460 cm⁻¹, and 480 cm⁻¹ to 650 cm⁻¹.
Polysilanes whose substituents consist of bromine have
   a) their significant product signals in ²⁹Si NMR spectra within the chemical shift range from −10 ppm to −42 ppm, from −46 ppm to −55 ppm and/or −63 ppm to −96 ppm,
   b) typical Raman intensities not outside the ranges of 10 cm⁻¹ to 150 cm⁻¹, 155 cm⁻¹ to 350 cm⁻¹, at 390 cm⁻¹ to 600 cm⁻¹, and at 930 cm⁻¹ to 1000 cm⁻¹.
Polysilanes whose substituents consist of iodine have
   a) significant product signals in ²⁹Si NMR spectra within the chemical shift range from −20 ppm to −55 ppm, from −65 ppm to −105 ppm and/or from −135 ppm to −181 ppm,
   b) typical Raman intensities not outside the ranges of 10 cm⁻¹ to 150 cm⁻¹, 155 cm⁻¹ to 600 cm⁻¹, and at 930 cm⁻¹ to 1000 cm⁻¹.
Polysilanes whose substituents consist of hydrogen have
   a) significant product signals in ²⁹Si NMR spectra within the chemical shift range from −65 ppm to −170 ppm,
   b) a characteristic band in Raman molecular vibration spectra in the range of 2000-2200 wavenumbers and no bands in the range from 2000 to 1100.

IR measurements were obtained on an FT/IR-420 spectrometer from Jasco Corp. as a KBr disk. Liquids were absorbed with preformed KBr disks or measured between NaCl plates.

Raman molecular vibration spectra were measured on an XY 800 spectrometer from Dilor with tunable laser excitation (T-sapphire laser, pumped by Ar ion laser) and confocal Raman and luminescence microscope, CCD detector cooled with liquid nitrogen, measurement temperature equal to room temperature, excitation wavelengths in the visible spectral range, including 514.53 nm and 750 nm.

²⁹Si NMR spectra were recorded on a 250 MHz instrument of the Broker OPX 250 type with the zg30 pulse sequence and referenced against tetramethylsilane (TMS) as an external standard [δ(²⁹Si)=0.0]. The acquisition parameters here are: TD=32 k, AQ=1.652 s, DI×10 s, NS=2400, O1P=−40, SW=400.

Our methods for preparing polysilanes of medium chain length SiₙX₂ₙ₊₂ and SiₙX₂ₙ where n is greater than 3 and less than 50, preferably greater than 3 and less than 9, more preferably greater than 3 and less than 7, and X═F, Cl, Br, I and/or H is characterized in that it comprises one or more of the synthesis steps described hereinafter.

The polysilanes may be obtained by plasma-assisted synthesis of halosilanes.

The polysilanes may also be obtained by plasma-assisted synthesis of halosilanes, the halogen being bromine.

The polysilanes may further be obtained by plasma-assisted synthesis of H-silanes and/or H-oligosilanes.

The polysilanes may still further be obtained by plasma-assisted synthesis of halogenated oligosilanes, particular preference being given to using halogenated di- and trisilanes.

The polysilanes may yet further be obtained by plasma-assisted synthesis of mixtures which also comprise organically substituted silanes and/or oligosilanes. For this purpose, for example, methylchlorosilanes are used.

During the plasma-assisted synthesis, preference is given to working with a halosilane:hydrogen mixing ratio of 1:0 to 1:2 and within a pressure range of 0.8-10 hPa.

The polysilanes may be obtained by hydrohalogenation with HCl and/or HBr for splitting of polysilanes of greater chain length. Preference is given here to working within a pressure range from 1 bar to 43 bar. The hydrohalogenation can be promoted by catalysts, for example, ammonium salts.

The polysilanes may also be obtained by catalytic coupling of disilanes and/or trisilanes with organylphosphonium and/or -ammonium salts as catalysts. This corresponds to a disproportionation reaction, forming short-chain polysilanes as by-products.

The polysilanes may further be obtained by Wurtz coupling of lower halosilanes (for example, disilanes and/or trisilanes) with alkali metals and/or magnesium. Particular preference is given to activated metals, for example, Rieke magnesium.

The polysilanes may be obtained by ring-opening polymerization of cyclosilanes (SiₙX₂ₙ) where n is preferably 4, 5 and/or 6.

The polysilanes may be obtained by coupling by dehydrohalogenation. This corresponds to a polycondensation with elimination of hydrogen halide molecules.

The polysilanes may be obtained by dehydrogenating coupling of hydrogenated and/or partly hydrogenated silanes with transition metal complexes.

The polysilanes may be obtained by hydrogenation of polysilanes of medium chain length. For this purpose, preference is given to using halogenated polysilanes. For hydrogenation of the polysilane, preference is given to using metal or metalloid hydrides.

The reactor parts where the above reactions take place are kept at a temperature of −70° C. to 500° C. especially −20° C. to 280° C.

The polysilanes may also be obtained by pyrolysis of polysilane, by disproportionating and isolating our polysilanes from the vapor phase. Preference is given here to working within a pressure range of 10-1013 hPa.

The polysilanes may be obtained by thermolytic chain extension over catalyst materials. After disproportionation of the starting material, preference is given to isolating the longer-chain component from the product mixture.

The polysilanes may be obtained by thermal reaction of silicon with SiX₄.

Various aspects of our polysilanes and methods are illustrated hereinafter by Working Examples and a Drawing.

### WORKING EXAMPLES

### Working Example 1

Synthesis of PCS: a mixture of 500 sccm of H₂ and 500 sccm of SiCl₄ (1:1) is introduced into a quartz glass reactor, with the process pressure kept constant within the range of 1.6-1.8 hPa. The gas mixture is then convened to the plasma state by a high-frequency discharge in the course of which the chlorinated polysilane formed precipitates on the cooled (20° C.) quartz glass walls of the reactor. The incident power is 400 W. After 2 hours, the yellow to orange-yellow product is removed from the reactor by dissolving in a little SiCl₄. Removal of the SiCl₄ under reduced pressure leaves 91.1 g of polysilane in the form of an orange-yellow viscous material. The mean molar mass is determined by cryoscopy to be approx. 1700 g/mol, which, for the chlorinated polysilane (SiCl₂)ₙ or SiₙCl₂ₙ₊₂, corresponds to a mean chain length of approx. n=17 for (SiCl₂)ₙ or approx. n=16 for SiₙCl₂ₙ₊₂.

### Working Example 2

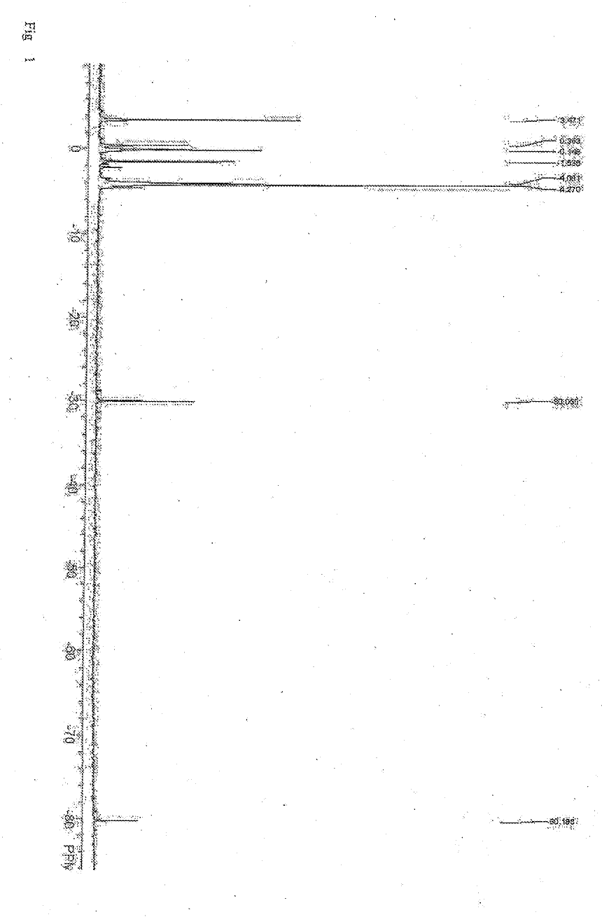

Plasma synthesis of PCS and subsequent thermolysis: a mixture of 300 sccm of H₂ and 600 sccm of SiCl₄ (1:2) is introduced into a quartz glass reactor, with the process pressure kept constant within the range of 1.5-1.6 hPa. The gas mixture is then converted to the plasma state by a high-frequency discharge in the course of which the chlorinated polysilane formed precipitates on the cooled (20° C.) quartz glass walls of the reactor. The incident power is 400 W. After 4 hours, the orange-yellow product is removed from the reactor by dissolving in a little SiCl₄. Removal of the SiCl₄ under reduced pressure leaves 187.7 g of chlorinated polysilane in the form of an orange-yellow viscous material. The mean molar mass is determined by cryoscopy and is approx. 1400 g/mol, which, for the chlorinated polysilane (SiCl₂)ₙ or SiₙCl₂ₙ₊₂, corresponds to a mean chain length of approx. n=14 for (SiCl₂)ₙ or approx. n=13 for SiₙCl₂ₙ₊₂. A 50-60% solution of this polychlorosilane mixture having an average empirical formula of SiₙCl₂ₙ (Øn=18) in SiCl₄ is initially charged in a glass vessel and heated to 300° C. at a pressure of 300 to 500 mbar within 2 to 3 h. Thereafter, the pressure is reduced stepwise to ultimately 10 mbar and heating is effected to 900° C. over the course of 3 h. Finally, the temperature is left at 900° C. for 1 h. The vapors which escape during the thermal decomposition of the polychlorosilane mixture are condensed in a cold trap cooled with liquid nitrogen. The polychlorosilane mixture is converted to a solid, highly crosslinked, chlorinated polysilane (chloride-containing silicon) of empirical formula SiCl_{0.05} to SiCl_{0.07} and short-chain chlorosilanes. On completion of the reaction, the vessel was allowed to cool and the solid product was withdrawn. Yields based on the starting material: 10-15% by mass of SiCl_{0.05} to SiCl_{0.07} and 85-90% by mass of short-chain chlorosilanes (diluents not included), with presence of about 35% of OCS. By distillation, a fraction of predominantly n=5 is isolated. In the ²⁹Si NMR spectrum (FIG. 1), it is clearly evident that this is an isomer mixture (3 compounds) of the chlorinated pentasilanes.

### Working Example 3

Plasma synthesis of PCS and subsequent chlorination: a mixture of 200 sccm of H₂ and 600 sccm of SiCl₄ vapor (1:3) is introduced into a quartz glass reactor, with the process pressure kept constant within the range of 1.50-1.55 hPa. The gas mixture is then converted to the plasma state by a high-frequency discharge in the course of which the chlorinated polysilane formed precipitates on the cooled (20° C.) quartz glass walls of the reactor. The incident power is 400 W. After 2 h 9 min, the orange-yellow product is removed from the reactor by dissolving in a little SiCl₄. Removal of the SiCl₄ under reduced pressure leaves 86.5 g of chlorinated polysilane in the form of an orange-yellow viscous material. The mean molar mass is determined by cryoscopy and is approx. 1300 g/mol, which, for the chlorinated polysilane (SiCl₂)ₙ or SiₙCl₂ₙ₊₂, corresponds to a mean chain length of approx. n=13 for (SiCl₂)ₙ or approx. n=12 for SiₙCl₂ₙ₊₂. 80 g of a chlorinated polysilane obtained are diluted with 36.5 g of Si₂Cl₆ and contacted with chlorine gas in a closed apparatus with vigorous stirring at a temperature of 100-131° C. for 24.5 h such that the pressure does not rise above 1213 hPa. This is followed by fractional distillation and removal of SiₙCl₂ₙ₊₂ where n=1-3 to obtain a residue of 9.25 g which, according to ²⁹Si spectroscopy analysis, consists principally of a plurality of neochlorosilanes and iso-Si₄Cl₁₀.

The chain length refers to the number of silicon atoms bonded directly to one another in a compound.

The term “medium chain length” used here relates to those compounds in which 3<n<50, preferably 2<n<9, more preferably 3<n<7.

The term “longer-chain” used here relates to those compounds in which n>3. n is the number of silicon atoms directly bonded to one another.

“Virtually no” is supposed to mean that less than 2% is present in the mixture.

“Predominantly” is understood to mean that the constituent in question is present to an extent of more than 50% in the mixture.

“Exclusively” is supposed to mean that a much lower level of impurities is present in the mixture than was usual at high purities for fine chemicals (e.g., >99%). Therefore, a purity of at least 99.9% is meant here.

“Inert solvents” are understood to mean solvents which, under standard conditions, do not react spontaneously with the (for example, halogenated) polysilane of medium chain length (called “polysilane” for short hereinafter) (for example, SiCl₄, benzene, toluene, paraffin, etc.).

The polysilane preferably meets the demands for applications in semiconductor technology, more preferably those as customary in photovoltaics.

The starting materials used may be monosilanes and/or polysilanes. Monosilanes refer to compounds of the HₙSiX₄₋ₙ type (X═F, Cl, Br, I; n=0-4), and polysilanes to compounds of the SiₙX₂ₙ and/or SiₙX₂ₙ₊₂ type (X═F, Cl, Br, I and/or H), and mixtures thereof.

1. A polysilane of medium chain length as a pure compound or mixture of compounds having at least one direct Si—Si bond in each case, substituents of which consist of halogen and/or hydrogen and a composition of which has an atomic substituent:silicon ratio of at least 1:1, wherein
a) the medium chain length is greater than 3 and less than 50,
b) said polysilane is soluble in inert solvents,
c) said polysilane is suitable as a starting material for silicon deposition,
d) said polysilane has oxygen- and chlorine-binding properties, and
e) said polysilane decomposes to longer- and shorter-chain products on thermal treatment.

2. The polysilane according to claim 1, having only bands in a range of less than 2400 wavenumbers in IR molecular vibration spectra.

3. The polysilane according to claim 1, having only bands in a range of less than 2300 wavenumbers in Raman molecular vibration spectra.

4. The polysilane according to claim 1, wherein
a) the halogen is fluorine,
b) significant product signals in ²⁹Si NMR spectra are within a chemical shift range from 8 ppm to −40 ppm and/or from −45 ppm to −115 ppm, and
c) Raman intensities are not outside the ranges of 10 cm⁻¹ to 165 cm⁻¹, 170 cm⁻¹ to 240 cm⁻¹, 245 cm⁻¹ to 360 cm⁻¹, 380 cm⁻¹ to 460 cm⁻¹, and 480 cm⁻¹ to 650 cm⁻¹ and at 900 cm⁻¹ to 980 cm⁻¹.

5. The polysilane according to claim 1, wherein
a) the halogen is chlorine,
b) significant product signals in ²⁹Si NMR spectra are within a chemical shift range from 15 ppm to −10 ppm, from −25 ppm to −40 ppm and/or −65 ppm to −96 ppm, and
c) Raman intensities are not outside the ranges of 10 cm⁻¹ to 165 cm⁻¹, 170 cm⁻¹ to 240 cm⁻, 245 cm⁻¹ to 360 cm⁻¹, 380 cm⁻¹ to 460 cm⁻¹, and 480 cm⁻¹ to 650 cm⁻¹.

6. The polysilane according to claim 1, wherein
a) the halogen is bromine,
b) significant product signals in ²⁹Si NMR spectra are within a chemical shift range from −10 ppm to −42 ppm, from −46 ppm to −55 ppm and/or −63 ppm to −96 ppm, and
c) Raman intensities are not outside the ranges of 10 cm⁻¹ to 150 cm⁻¹, 155 cm⁻¹ to 350 cm⁻¹, at 390 cm⁻¹ to 600 cm⁻¹, and at 930 cm⁻¹ to 1000 cm⁻¹.

7. The polysilane according to claim 1, wherein
a) the halogen is iodine,
b) significant product signals in ²⁹Si NMR spectra are within a chemical shift range from −20 ppm to −55 ppm, from −65 ppm to −105 ppm and/or from −135 ppm to −181 ppm, and
c) Raman intensities are not outside the ranges of 10 cm⁻¹ to 150 cm⁻¹, 155 cm⁻¹ to 600 cm⁻¹, and at 930 cm⁻¹ to 1000 cm⁻¹.

8. The polysilane according to claim 1, wherein
a) the substituents consist of hydrogen,
b) significant product signals in ²⁹Si NMR spectra are within a chemical shift range from −65 ppm to −170 ppm, and
c) a characteristic band in Raman molecular vibration spectra are in a range of 2000-2200 wavenumbers and no bands in a range from 2000 to 1100.

9. The polysilane according to claim 1, containing virtually no short branched chains and rings, content of branching sites in the short-chain component based on the overall product mixture being less than 2%.

10. The polysilane according to claim 1, having a high content of short branched chains and rings, content of branching sites in the short-chain component based on the overall product mixture being greater than 2%.

11. The polysilane according to claim 1, containing halogen substituents of a plurality of different halogens.

12. The polysilane according to claim 1, wherein substituents thereof consist exclusively of halogen or of halogen and hydrogen.

13. The polysilane according to claim 1, containing predominantly linear long chains.

14. The polysilane according to claim, wherein mean size of a base structure of the polysilane is n=8-20.

15. The polysilane according to claim 1, wherein mean size of a base structure of the polysilane is, after distillative removal of the short-chain polysilanes, n=15-30.

16. The polysilane according to claim 1, which is viscous to solid.

17. The polysilane according to claim 1, having a greenish-yellow to intense orange or red-brown color, if any, as a chlorinated polysilane, and is colorless to yellow as a brominated or hydrogenated polysilane.

18. The polysilane according to claim 1, which is completely soluble in inert solvents.

19. The polysilane according to claim 1, containing less than 2 atom % of hydrogen.

20. A method for preparing polysilanes of medium chain length SiₙX₂ₙ₊₂ and SiₙX₂ₙ where n is greater than 3 and less than 50, and X═F, Cl, Br, I and/or H according to claim 1, comprising one or more of the following synthesis steps:
a) plasma-assisted synthesis of halosilanes,
b) plasma-assisted synthesis of halosilanes, the halogen being bromine,
c) plasma-assisted synthesis of H-silanes and/or H-oligosilanes,
d) plasma-assisted synthesis of halogenated oligosilanes,
e) plasma-assisted synthesis of mixtures which also comprise organically substituted silanes and/or oligosilanes,
f) hydrohalogenation for splitting of polysilanes with HCl and/or HBr,
g) catalytic coupling of disilanes and/or trisilanes with organylphosphonium and/or -ammonium salts,
h) Wurtz coupling of lower halosilanes with alkali metals and/or magnesium,
i) ring-opening polymerization of cyclosilanes (SiₙX₂ₙ),
j) coupling by dehydrohalogenation,
k) dehydrogenating coupling of partly hydrogenated slimes with transition metal complexes,
l) hydrogenation of polysilanes of medium chain length,
m) pyrolysis of polysilanes,
n) thermolytic chain extension over catalyst materials,
o) thermal reaction of silicon with SiX₄.

21. The method according to claim 20, wherein metal or metalloid hydrides are used in hydrogenation of the polysilane.

22. The method according to claim 20, wherein a halosilane:hydrogen mixing ratio of 1:0 to 1:2 is employed in the case of plasma-assisted synthesis.

23. The method according to claim 20, wherein a pressure of 0.8-10 hPa is employed during the plasma-assisted synthesis.

24. The method according to claim 20, wherein a pressure of 10-1013 hPa is employed during the pyrolysis.

25. The method according to claim 20, wherein a pressure range of 1 bar to 43 bar is employed during hydrohalogenation.

26. The method according to claim 20, wherein reactor parts where reaction takes place are kept at a temperature of −70° C. to 500° C.

27. The method according to claim 20, wherein the plasma-assisted synthesis of PCS is followed by thermolytic treatment.

28. The method according to claim 20, wherein the plasma-assisted synthesis of PCS is followed by chlorination.
